(19) United States
(12) Patent Application Publication
(10) Pub. No.: US 2005/0173904 A1
(43) Pub. Date: Aug. 11, 2005

(54) Control system for vehicle occupant protection apparatus

(75) Inventor: Kenji Morikawa, Hekinan-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/043,193

(22) Filed: Jan. 27, 2005

(30) Foreign Application Priority Data
Feb. 9, 2004 (JP) 2004-31660

(51) Int. Cl. B60R 21/32

(52) U.S. Cl. 280/735

(57) ABSTRACT

In a vehicle occupant protection apparatus comprising, a seat of a vehicle occupant is mounted on a floor of the vehicle at a front connecting portion and a rear connecting portion. A weight detecting unit is provided at the rear connecting portion between a rear portion of the seat and the floor of the vehicle and for outputting a weight signal corresponding to a product of a weight of the occupant sitting on the seat multiplied by a distance of a gravity of the occupant from the front connecting portion. A control unit operates an air bag in accordance with the weight signal and the crash signal.

### CROSS REFERENCE TO RELATED APPLICATION

This application is based on Japanese Patent Application No. 2004-31660 filed on Feb. 9, 2004, the disclosure of which is incorporated herein by reference.

### FIELD OF THE INVENTION

The present invention relates to a control system for a vehicle occupant protection apparatus, which controls the vehicle occupant protection apparatus in accordance with a condition of an occupant sitting on a vehicle seat.

### BACKGROUND OF THE INVENTION

It has been recently required, according to the US law FMVSS article 208 and the like in relation to an air-bag system installed in a vehicle as an occupant protection apparatus, that two contrary characteristics must be realized in a high level. Namely, one of them is a high occupant protection performance in case of a vehicle crash, and the other one is a decrease of offending possibility to a vehicle occupant, in particular to babies or little children.

It is disclosed in Japanese Paten Publication No. 2001-310668 that a body type of an occupant is judged in accordance with his weight which is measured by a weight sensor provided in a vehicle seat, or in another Japanese Patent Publication No. 2003-127824 that an occupant position is detected by a photographic image around the vehicle seat.

It is, however, according to the above Japanese Patent Publication No. 2001-310668, necessary to provide multiple weight sensors in the vehicle seat, namely at least at four different positions of the seat (a forward right and left, and a backward right and left positions of one seat). Furthermore, it may be necessary to provide a certain means, such as a weight stopper or a link mechanism, for preventing the seat and the weight sensors from being broken down at the vehicle crash, And thereby, the weight sensors may become inevitably large in size and high in cost.

On the other hand, according to the above other Japanese Patent Publication No. 2003-127824, it is necessary to provide an image sensor and a highly advanced calculating devices for the image data processing for judging whether any occupant is seated on the seat, whether the occupant is a baby or little child, and so on. As a result, such system is also high in cost.

In the case that the expansions of the air bags are controlled, bottoming of the air bags must be prevented. For example, the air bag must be expanded at a higher expansion pressure for such an occupant having a heavier weight. However, if the air bag was expanded at such a high expansion pressure for an occupant having a light weight, such as a little child, or for the occupant having the heavier weight but sitting at a forward position of a seat, or for the occupant sitting at a normal position of the seat but an upper body being forwardly inclined, an offending characteristic to the occupant by the expansion of the air bag would be reversely increased.

It is, therefore, required to control the expansion of the air bag in accordance with the weight of the occupant as well as the position of the occupant sitting on the seat (a distance of the occupant from the air bag), to realize the contrary characteristics in the higher level, namely, the improvement of the occupant protection performance and the reduction of the offending characteristic.

### SUMMARY OF THE INVENTION

The present invention is made in view of the above problems, and it is an object of the present invention to provide a vehicle occupant protection apparatus, which is capable of properly performing a control operation of the occupant protection apparatus in accordance with occupant sitting conditions containing a physique and a seat sitting position of the occupant, while a simple control system can be made in low cost.

According to a feature of the present invention, a vehicle occupant protection apparatus comprises; an occupant protecting device such as an air bag device; a vehicle seat for an occupant, which is mounted on a floor of the vehicle at a front connecting portion and a rear connecting portion; a weight detecting unit provided at the rear connecting portion between a rear portion of the seat and the floor of the vehicle and for outputting a weight signal corresponding to a product of a weight of the occupant sitting on the seat and a distance of a gravity of the occupant from the front connecting portion; a crash sensor provided in the vehicle for outputting a vehicle crash signal; and an electronic control unit for operating the occupant protecting device in accordance with the weight signal and the crash signal.

As a result, the occupant protection apparatus according to the present invention can be made in a simple structure and at low cost. At the same time, the compatibility between the occupant protecting performance and lowering of the off ending characteristic can be improved.

According to another feature of the present invention, a front portion of the seat is fixed to the vehicle floor via a mechanical hinge or an elastic hinge at the front connecting portion, so that a substantial amount of the weight at the rear portion of the seat is applied to the weight detecting unit. As a result, the weight detecting unit can output a detection signal corresponding to a product calculated between the occupant weight and the distance of the occupant gravity from the front portion of the seat in high precision.

According to a further feature of the present invention, the vehicle seat is mounted on a seat sliding device, which comprises a pair of lower seat rails, a pair of upper seat rails connected to the lower seat rails in a slidable manner, and a seat frame of the seat is fixed to the upper seat rails at the front and rear connecting portions via the mechanical or the elastic hinge and the weight detecting unit.

With such an arrangement, the weight detecting unit can likewise output a detection signal corresponding to a product calculated between the occupant weight and the distance of the occupant gravity from the front portion of the seat in high precision.

According to a still further feature of the present invention, a mechanical rigidity of the front connecting portion is lower than that of the weight detecting unit, so that a substantial amount of the weight at the rear portion of the seat is applied to the weight detecting unit.

According to a still further feature of the present invention, the seat is mounted on a seat sliding device, which comprises a pair of lower seat rails, a pair of upper seat rails connected to the lower seat rails in a slidable manner, and a seat frame of the seat is fixed to the upper seat rails, and the lower seat rails are connected to the vehicle floor at the front and rear connecting portions. And a pair of weight detecting unit is provided at the left and right rear connecting portions.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of an occupant protection apparatus according to an embodiment of the present invention;

FIG. 2 is a perspective view of a seat for a vehicle;

FIG. 3 is also a perspective view showing a seat frame of the seat of FIG. 2;

FIG. 4 is an enlarged side view showing a front portion of the seat frame;

FIG. 5 is an enlarged side view showing a rear portion of the seat frame;

FIG. 6 is a perspective view showing a weight detecting unit;

FIG. 7 is a schematic cross sectional view of the weight detecting unit;

FIGS. 8A and 8B are explanation charts for showing a principle of detecting weight applied to the seat frame;

FIG. 9 is a graph showing a relationship between detected weight values and a distance of gravity of an occupant on the seat from a forward end of the seat;

FIG. 10 is also a schematic view showing a relation between the occupant and the seat;

FIG. 11 is a flow chart showing an operational process of the occupant protection apparatus according to the embodiment;

FIG. 12 is an enlarged side view of the front portion of the seat frame according to a first modification;

FIG. 13 is an enlarged side view of the front portion of the seat frame according to a second modification; and

FIG. 14 is an enlarged side view of the front portion of the seat frame according to a third modification.

### DETAILED DESCRIPTION OF THE PREFERRED EMBODIMENTS

An embodiment of the present invention for a control system for an occupant protection apparatus is explained with reference to the drawings.

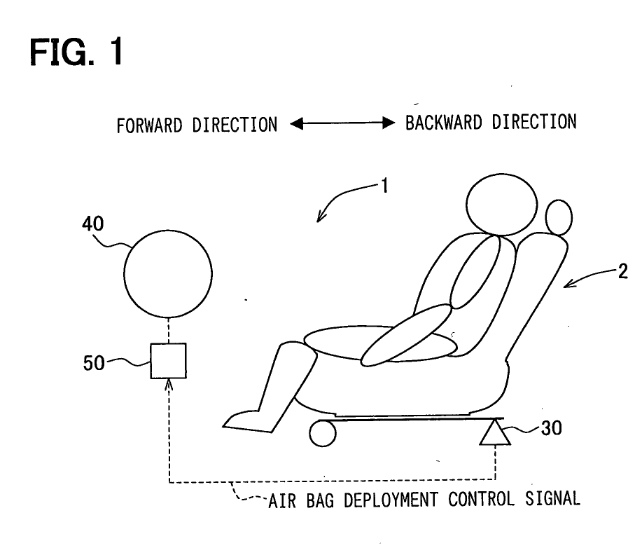

As shown in FIG. 1, an occupant protection apparatus 1 according to the embodiment of the present invention comprises a seat 2, a weight detecting unit 30 provided at a rear portion of the seat 2, an occupant protecting device 40, such as an air bag device for protecting an occupant, and an electronic control unit 50 for operating the air bag device 40 based on a signal from a crash sensor (not shown) and a signal from the weight detecting unit 30.

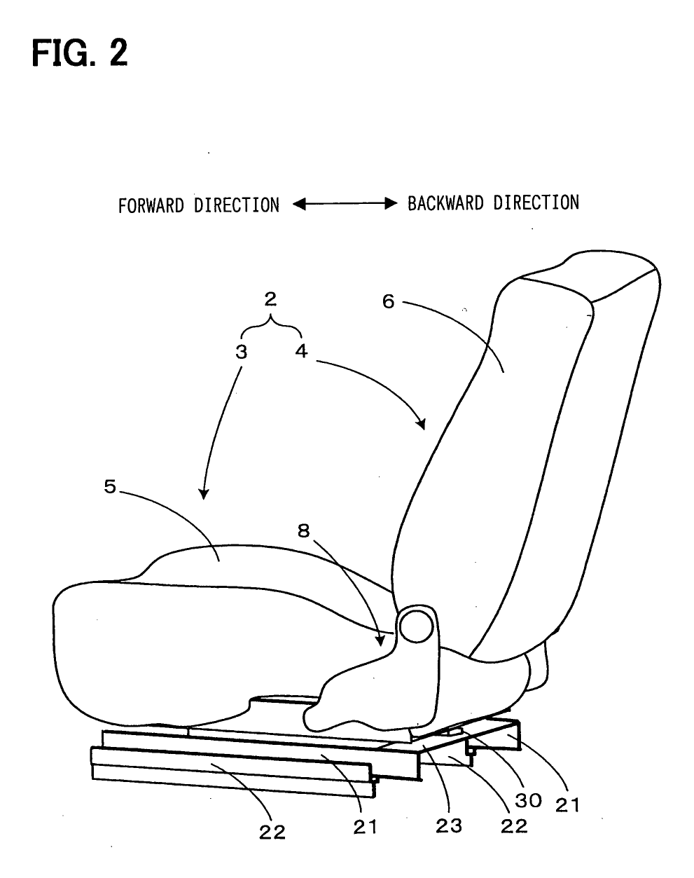

As shown in FIG. 2, the seat 2 has a sitting seat portion 3 on which the occupant sits and a seat back portion 4, wherein a seat cushion 5 is mounted on the sitting seat portion 3 and a seat back pad 6 is mounted on the seat back portion 4.

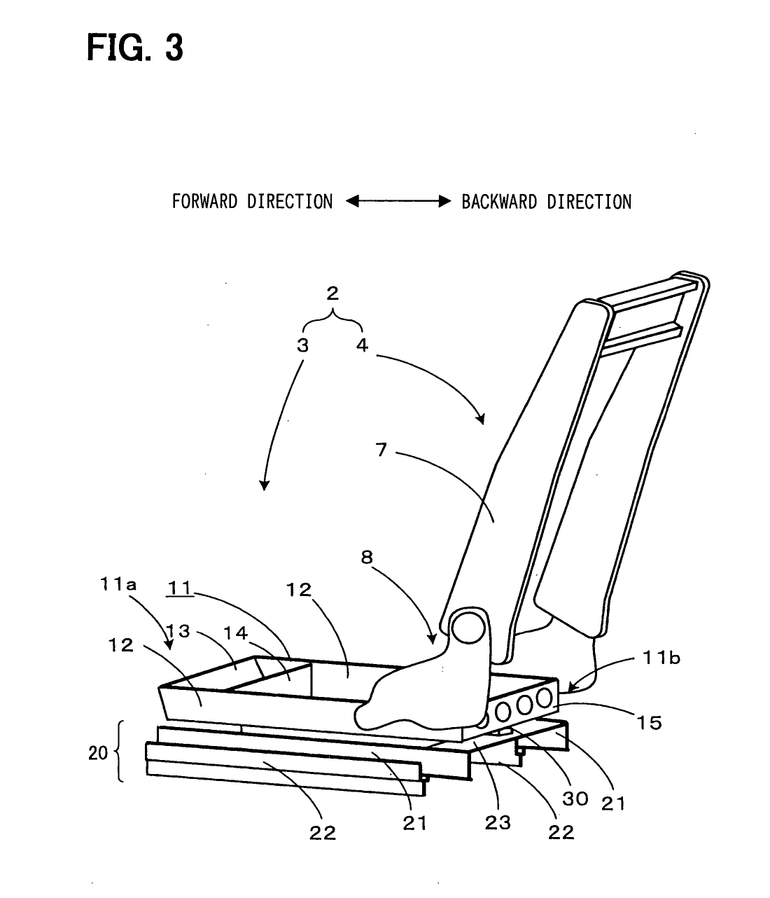

As shown in FIG. 3, the sitting seat portion 3 comprises a seat frame 11 and a seat sliding device 20. The seat sliding device 20 comprises a pair of upper seat rails 21 of right and left sides, a pair of lower seat rails 22 of right and left sides, and a rail coupling bar 23 connecting the pair of the upper seat rails 21. The seat back portion 4 comprises a seat back frame 7, on which the seat back pad 6 is mounted, and the seat back portion 4 is connected via a reclining mechanism 8 to a rear end of the seat frame 11 so that the seat back frame 7 is pivoted to the seat frame 11 and movable in a forward or a backward directions.

The seat frame 11 corresponds to a frame member for supporting the seat cushion 5. The seat frame 11 is equipped with a right and a left frame members 12, and three coupling members 13, 14 and 15. The right and left frame members 12 are extended in a longitudinal direction. The coupling members 13, 14 and 15 are respectively connected to the right and left frame members 12 at front ends, middle portions and rear ends thereof.

The frame members 12 are connected to the upper seat rails 21 at a front and a rear portion of the frame members 12. The upper seat rails 21 are connected to the lower seat rails 22, so that the frame members 12 as well as the upper seat rails 21 are slidable on the lower seat rails in a forward and backward direction.

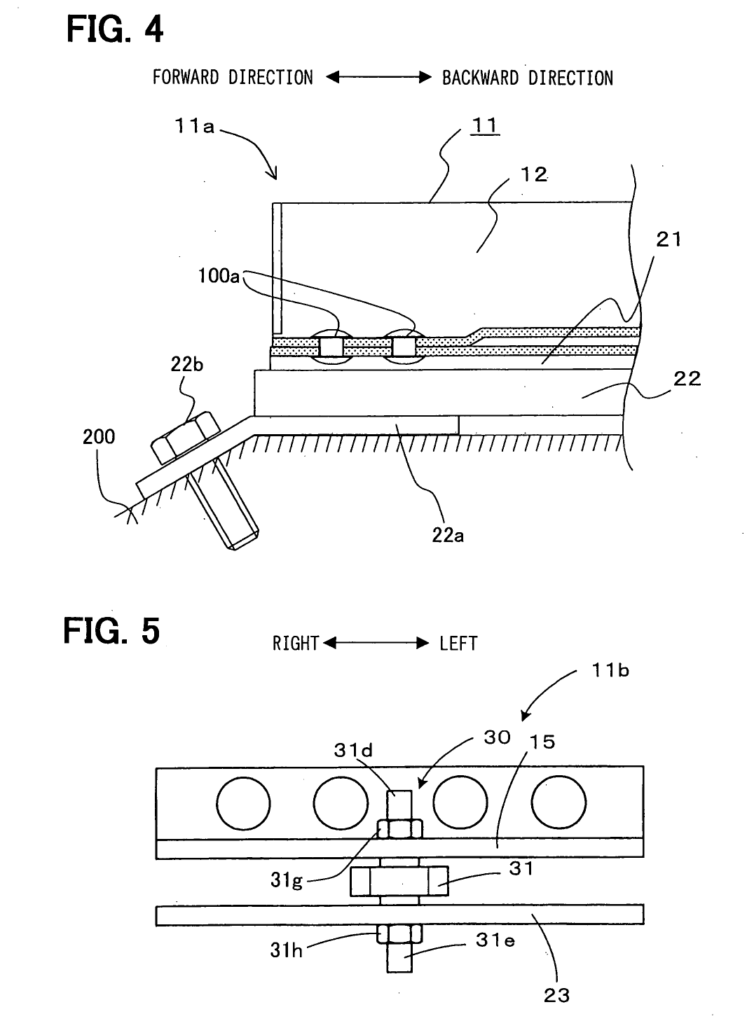

A front portion of the seat frame 11 is fixed to the upper seat rails 21 by multiple rivets 100a, as shown in FIG. 4. The connected portion is referred to as a front connecting portion 11a.

At a rear portion of the seat frame 11, as shown in FIG. 5, the coupling member 15 and the rail coupling bar 23 are connected via the weight detecting unit 30 at a laterally middle portion of the coupling member 15. The connected portion is referred to as a rear connecting portion 11b.

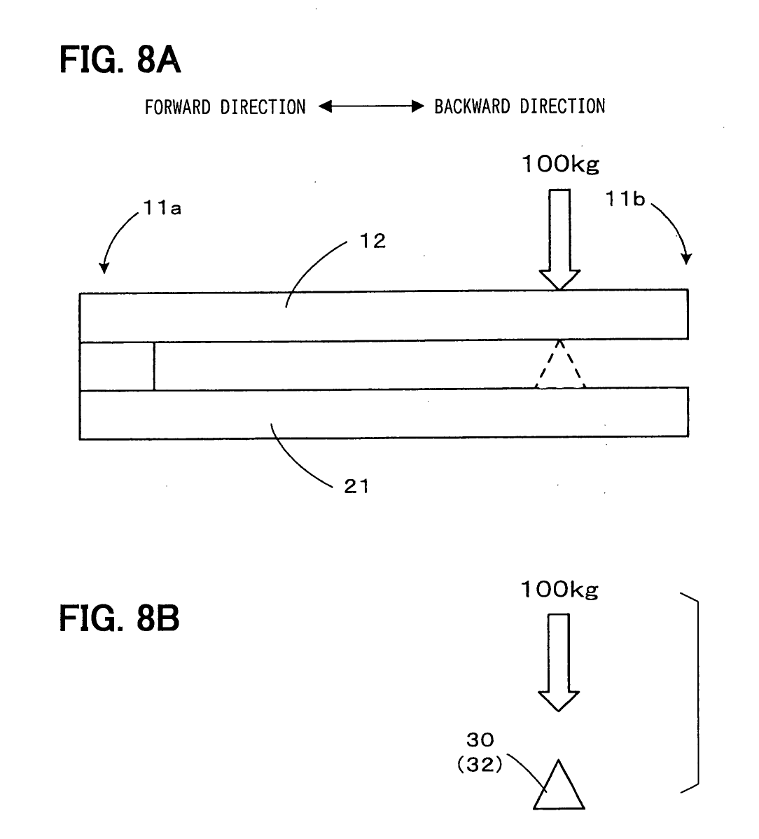

As more apparent from FIG. 8 (which will be explained later), the seat frame 11 is connected to the upper seat rails 21 at the front and rear connecting portions 11a and 11b.

As shown in FIG. 4, multiple brackets 22a (only one bracket 22a is shown in FIG. 4) are fixed to the lower seat rails 22 (at the front and rear ends) by welding or any other fixing means. And the lower seat rails 22 are fixed to a floor 200 of a vehicle, via the multiple brackets 22a by multiple bolts 22b.

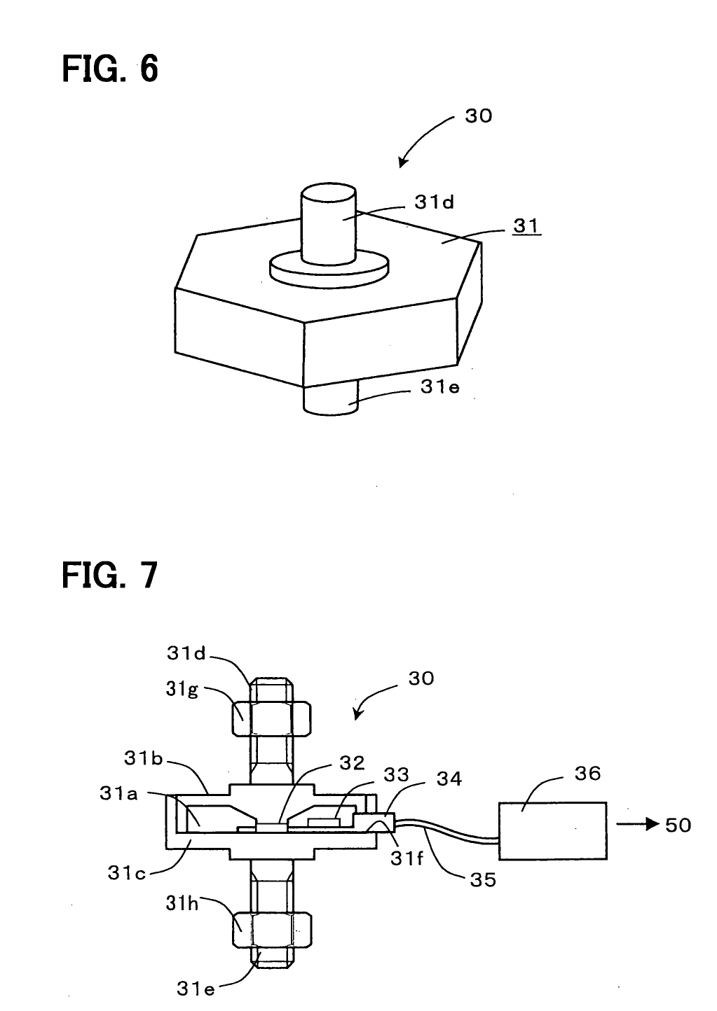

A structure of the weight detecting unit 30 will be explained with reference to FIG. 6 and FIG. 7. The weight detecting unit 30 comprises a diaphragm 31, a ceramic resistance element 32, an IC circuit 33, and a bus bar 34. The diaphragm 31 is formed into a hexagonal shape as viewed in a plane, and an inner space 31a is formed inside the diaphragm 31. Both the ceramic resistance element 32 and the IC circuit 33 are stored in the space 31a of the diaphragm 31. The bus bar 34 is provided on a side wall of the diaphragm 31.

As shown in FIG. 7, the diaphragm 31 is composed of an upper and lower housing members 31b and 31c. An upper shaft 31d upwardly extending is provided at a center of the upper housing member 31b, whereas a lower shaft 31e downwardly extending is provided at a center of the lower housing member 31c. Male screw portions are respectively formed at an outer peripheral portion of the upper and lower shafts 31d and 31e. The upper shaft 31d is fixed to the coupling member 15 of the seat frame 11 by a nut 31g, and the lower shaft 31e is fixed to the rail coupling bar 23 by a nut 31h.

The ceramic resistance element 32 is arranged between a lower plane of the upper housing member 31b and an upper plane of the lower housing member 31c at a center portion of the inner space 31a within the diagram 31. The ceramic resistance element 32 is contacted with the upper and the lower housing members 31b and 31c, so that a predetermined pressure is applied to the ceramic resistance element 32.

Since the diaphragm 31 is fixed to the coupling member 15 and the rail coupling bar 23 by means of screw-nut coupling, the weight detecting unit 31 can detect the stress in both directions, namely the compression and tension. Furthermore, the predetermined pressure is in advance applied to the ceramic resistance element 32, so that the diaphragm 31 can stably detect the stress applied to the ceramic resistance element 32 in the both directions. And also, the tension strength at the fastening portion of the rear portion 11b of the seat frame 11 is secured.

In this embodiment, the ceramic resistance element 32 constitutes a detecting unit of the present invention, and the diaphragm 31 constitutes a pre-weight applying means.

The ceramic resistance element 32 is made of ceramic material, for instance, zirconia as a major material, which changes its electrical resistance when an external force is applied. Accordingly, the stress (weight) can be detected by detecting the variation of the electrical resistance of the ceramic resistance element 32. The ceramic resistance element 32 is characterized in that the ceramic resistance element 32 owns extremely high rigidity, as compared with that of a strain-gage type weight sensor which is widely used.

Any other types of the sensors can be used as the weight detecting unit 31, in stead of the ceramic resistance element 32, for instance, the well known mechanical amount sensors may be employed which are disclosed in, for instance, Japanese Patent Publications No. 2001-242019 or No. 2002-202209.

The IC circuit 33 is electrically connected to the ceramic resistance element 32, and comprises a circuit portion for outputting a detected weight signal by detecting a change in electric resistances of the ceramic resistance element 32 and a circuit portion for outputting a deployment control signal for the air bag device based upon the detected weight signal. The ceramic resistance element 32 and the IC circuit 33 constitute weight detecting means of the present invention.

The IC circuit 33 is mounted on the lower housing member 31c within the space 31a of the diaphragm 31. The bus bar 34 is a terminal member from which a lead wire 35 is derived, and the lead wire 35 transfers an electric signal outputted from the IC circuit 33. The bus bar 34 is fixed to the diaphragm 31 in such a manner that the bus bar 34 is inserted into a hole 31f formed in the side portion of the diaphragm 31 and is resin-molded. As a result, the inner space 31a is air-tightly sealed. A waterproof connector 36 is provided at the other end of the lead wire 35.

The weight detecting unit 30 is electrically connected via the waterproof connector 36 to the electronic control unit 50, which controls an operation of the air bag device 40 based on the deployment control signal from the weight detecting unit 30 and a signal indicative of a strength of a vehicle crash sensed by a G sensor, etc.

An operation of the respective units of the above embodiment will be explained. At first, a basic principle for detecting weight of a sitting occupant on the seat 2 will be explained with reference to FIGS. 8A and 8B, in which the weight is detected by a single ceramic resistance element 32 with high precision.

As described before, the seat frame 11 (the left and right frame members 12) is connected to the upper seat rails 21 at the front connecting portion 11a and the rear connecting portion 11b, at which the weight detecting unit 30 is provided. And a mechanical rigidity of the front connecting portion 11a is formed to be much lower than that of rear connecting portion 11b (the weight detecting unit 30), so that a substantial amount of the weight at the rear portion of the seat 2 is applied to the weight detecting unit 30.

For example, in a model shown in FIG. 8A, in the case that flexure of 1 mm is generated when weight of 100 Kg is applied to the rear portion of the seat frame 11 (the rear connecting portion 11b), a flexure amount of the frame member 12 is given as “δ seat=1 mm/100 Kg”. On the other hand, as shown in FIG. 8B, in such a case that weight of 100 Kg causes the ceramic resistance element 32 of the weight detecting unit 30 to produce flexure of 1 μm, a flexure amount of the ceramic resistance element 32 is given as “δ sensor≦1 μm/100 Kg”.

In the structure, in which the weight detecting unit 30 is arranged at the rear portion of the seat frame 11, a weight loading ratio of the frame member 12 to the ceramic resistance element 32 is determined based upon a ratio of flexure amounts of both the frame member 12 and the ceramic resistance element 32 (in other words, ratio of rigidity of both members), when weight is applied to the rear portion of the seat frame 11.

As a consequence, a weight load “Fs” of the ceramic resistance element 32 is given as follows:
FS=100 Kg×δ seat/(δ seat+δ sensor)≧99.9 Kg.

In other words, a detected weight value in the weight detecting unit 30 becomes larger than, or equal to 99.9 Kg with respect to the applied weight of 100 Kg. As a result, the weight applied to the seat 2 can be detected in high precision by the single ceramic resistance element 32 arranged at the rear connecting portion 11b of the seat frame 11.

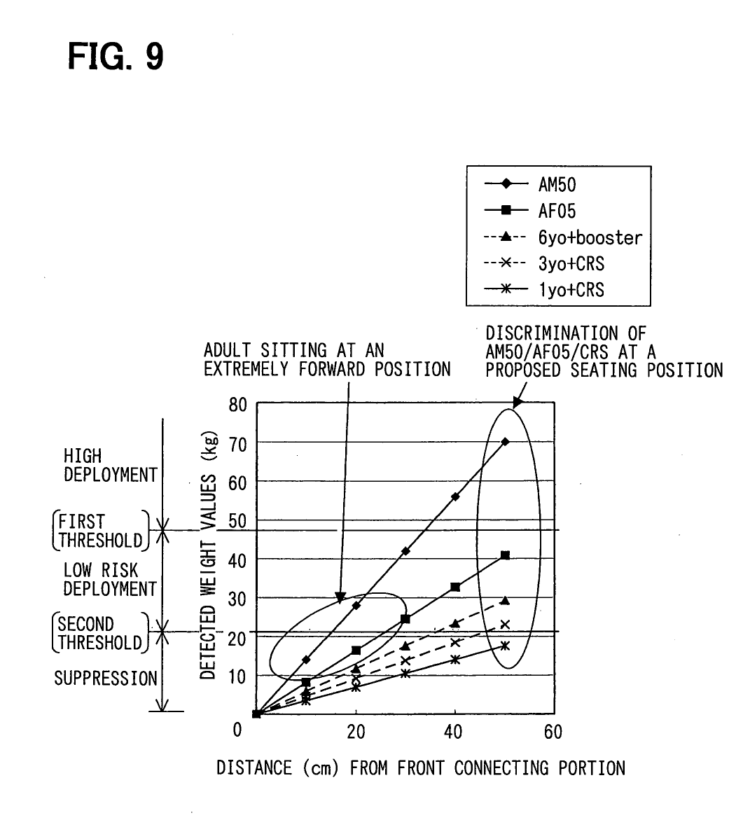

A relationship, between the detected weight values by the weight detecting unit 30 and distances from the front connecting portion 11a of the seat frame 11 to gravity positions of occupant, will be explained with reference to FIG. 9. In FIG. 9, an ordinate indicates detected weight values and an abscissa indicates the distance of the gravity positions from the front connecting portion 11a.

A line “AM50” is measurement results for a 50^{th} percentile adult male having weight of 80 Kg, a line “AF05”, for a 5^{th} percentile adult female having weight of 48 Kg, a line “6yo+booster” for a 6-years-old child using a booster seat, a line “3yo+CRS” for a 3-years-old child using a child restraint, and a line “1yo+CRS” for a 12-month-old child using a child restraint.

As apparent from FIG. 9, a direct proportional relationship is existing between the detected weight values and the distances of the gravity positions from the front connecting portion 11a. For instance, in the case of the adult male (AM50) having the weight of 80 Kg, a detected weight value is equal to 70 Kg at such a normal seat sitting position (accurately the proposed range of seating position) where a distance from the front connecting portion 11a to the gravity position of the occupant is 50 cm. And as the gravity position is moved toward the forward direction (40 cm, 30 cm, 20 cm, and 10 cm), the detected weight values are correspondingly decreased (56 Kg, 42 Kg, 28 Kg, and 14 Kg). When the gravity position is at a “0” cm from the front connecting portion, the detected weight value is “0” Kg.

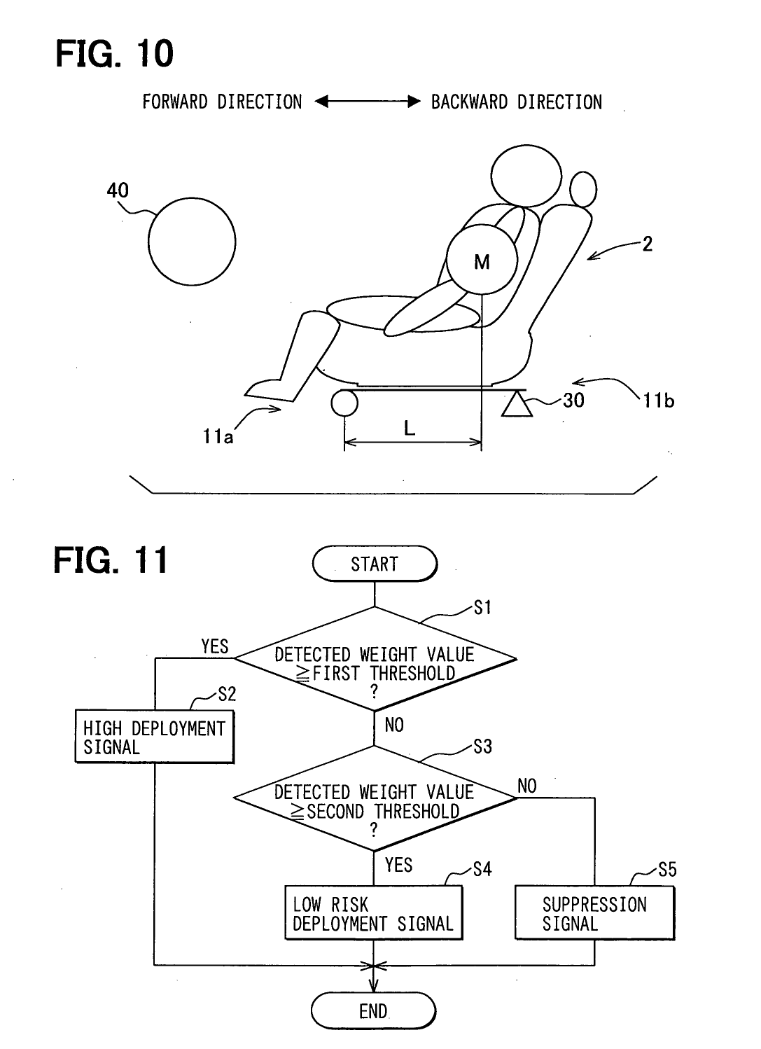

As above, a value corresponding to a product between a mass M and a distance L is detected by the ceramic resistance element 32, wherein the mass M is a mass of an upper body of an occupant, and the distance L is a distance of the gravity of the occupant from the front connecting portion 11a, as indicated in FIG. 10.

It has been known that the smaller a physique (namely, mass M) of an occupant becomes, the larger an offending characteristic becomes, whereas the larger the physique (mass M) of the occupant becomes, the smaller the offending characteristic becomes.

According to the US laws and regulations, obstacle values when a vehicle crashes under the conditions of AM50, AF05, and CRS (child restraint is mounted) at the proposed range of seating position have been defined. And the obstacle values can be satisfied by detecting AM50, AF05 and CRS at the respective proposed range of seating positions (Refer to FIG. 9).

It has been also known that the closer a seat sitting position of an occupant is located to an air bag, the larger an offending characteristic becomes, whereas the further separated the seat sitting position of the occupant is from the air bag, the smaller the offending characteristic becomes.

In the case that a distance from the air bag 40 to the front connecting portion 11a is fixed, a distance from the air bag 40 to the seat sitting position of the occupant is determined based upon a distance “L” defined from the above-described front connecting portion 11a to the gravity position of the occupant. As a consequence, the shorter the distance “L” becomes the larger the offending characteristic caused by the deployment of the air bag 40 becomes, whereas the longer the distance “L” becomes, the smaller the offending characteristic becomes.

According to the embodiment of the present invention, the IC circuit 33 is arranged in such a manner that the IC circuit 33 outputs a deployment control signal of the air bag 40 based upon a detected weight value (namely, value corresponding to product by mass “M” and distance “L”) obtained from a change of electric resistances in the ceramic resistance element 32.

The deployment control signals are outputted in response to deployment modes of the air bag 40, wherein the deployment modes have three different stages, namely, a high deployment mode; a low risk deployment mode; and a suppression mode.

The “high deployment” mode is a mode in which a deployment amount of the air bag 40 is maximum. For example, in the case that an adult male sits at the proposed range of seating position, a deployment control signal (will be referred to as “high deployment signal” hereinafter) corresponding to the high deployment mode is outputted from the IC circuit 33.

The “low risk deployment” mode is a mode in which a deployment amount of the air bag 40 is suppressed to a predetermined deployment amount (for instance, 60% of maximum deployment amount). In the case that an adult female sits at the proposed range of seating position; in the case that a child of 6 years old sits on the booster seat; in the case that an adult male sits at a slightly forward position from the proposed range of seating position; and the like, a deployment control signal (will be referred to as “low risk deployment signal” hereinafter) corresponding to the low risk deployment mode is outputted.

The “suppression” mode is a mode that the air bag 40 is not deployed. For instance, in the case that a child of 12-month-old sits on a child restrained; in the case that occupants of all types of physiques including an adult male sit at extremely forward positions from the proposed range of seating position; and the like, a deployment control signal (will be referred to “suppression signal” hereinafter) corresponding to the suppression mode is outputted.

As to the detected weight value (namely, value corresponding to mass “M”×distance “L”) based on the output of the ceramic resistance element 32, as shown in FIG. 9, a first threshold value is set to 48 Kg for discriminating the high deployment condition from the low risk deployment condition, and a second threshold value is set to 21 Kg for discriminating the low risk deployment condition from the suppression condition. The first and second threshold values of 48 kg and 21 Kg are merely exemplified as one example, and therefore, any other proper threshold values may be set in correspondence with vehicles on which the occupant protection system is mounted.

A process for the deployment control signals will be explained with reference to a flow chart shown in FIG. 11. The process for the deployment control signal is performed in the IC circuit 33, which comprises a CPU, a ROM, a RAM (not shown in the drawing), and the like. The CPU reads a program stored in the ROM to perform the program.

At a step S1, the CPU determines whether a detected weight value from the ceramic resistance element 32 is larger than, or equal to the first threshold value. And in the case that the detected weight value is larger than, or equal to the first threshold value (S1: Yes), the process goes to a step S2 at which the IC circuit 33 outputs the “high deployment” signal. On the other hand, in the case that the detected weight value is smaller than the first threshold value (S1: No), the process goes to a step S3, at which the CPU determines whether or not the detected weight value is larger than, or equal to, the second threshold value.

In the case that the detected weight value is larger than, or equal to the second threshold value (S3: Yes), the process goes to a step S4, at which the IC circuit 33 outputs the “low risk deployment” signal. On the other hand, in the case that the detected weight value is smaller than the second threshold value (S3: No), the process goes to a step S5, at which the IC circuit 33 outputs the “suppression” signal.

As above, according to the occupant protection system 1, when the occupant sits on the seat 2, the ceramic resistance element 32 of the weight detecting unit 30, which is provided between the seat rear portion and the vehicle body, outputs such a value corresponding to the product calculated by multiplying the weight of the occupant and the distance of the occupant gravity from the seat front portion. And the IC circuit 33 outputs the deployment control signal of the air bag 40 based upon the output value of the ceramic resistance element 32.

Then, the electronic control unit 50 deploys the air bag 40 in accordance with the deployment mode (namely, high deployment mode, low risk deployment mode, or suppression mode) designated by the deployment control signal outputted from the weight detecting unit 30, when the crash of the vehicle is sensed by the crash sensor.

According to the occupant protection system 1, the deployment control operation of the air bag 40 is carried out in a proper manner in response to the occupant conditions which contain the physiques and the seat sitting positions of the occupants, at the same time the simple and low cost arrangement of the occupant protection system 1 is realized. Furthermore, the compatibility between the occupant protection performance of the air bag 40 and lowering of the offending characteristic thereof with respect to the occupant can be improved.

Furthermore, since the weight detecting unit 30 is provided between the coupling member 15 and the rail coupling bar 23, the weight detecting operation can be carried out in high precision by merely providing the weight detecting means at one place. Also, since both the ceramic resistance element 32 and the IC circuit 33 are built in the diaphragm 31, both the weight detecting operation and the air bag deployment control operation executed in response to the occupant condition can be realized by the single unit. In particular, since the compact ceramic resistance element 32 having the high rigidity is employed as the weight detecting unit, the weight detecting unit 30 can be made in a very small size.

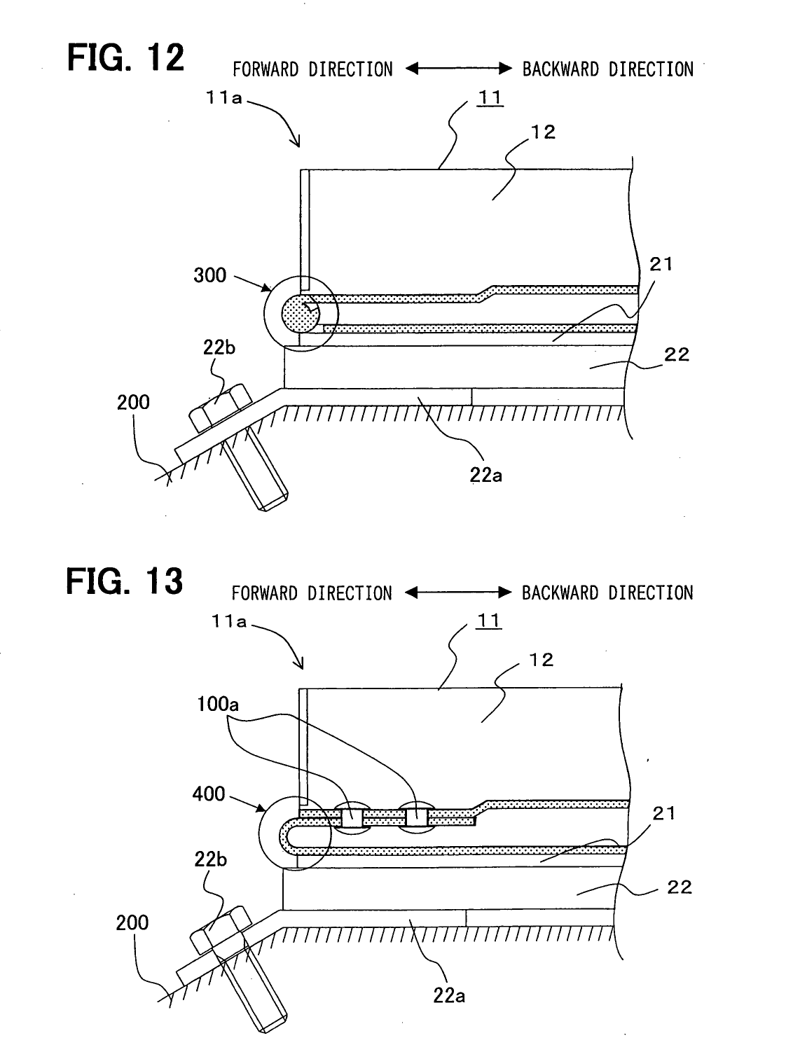

A first modification of the present invention is explained with reference to FIG. 12. In the modification, a mechanical hinge 300 is employed as the fastening structure of the front connecting portion 11a of the seat frame 11. That is, in the front connecting portion 11a of the seat frame 11, the frame member 12 is connected via the mechanical hinge 300 to the upper seat rail 21, so that the seat frame 11 can pivot at the hinge 300. The rigidity of the front fastening portion of the seat frame 11 is thereby very small with respect to the rigidity of the rear connecting portion 11b which is fastened via the weight detecting unit 30 containing the ceramic resistance element 32, and thereby the weight can be detected in the high precision by the ceramic resistance element 32.

A second modification of the present invention is explained with reference to FIG. 13. In the modification, an elastic hinge 400 is employed as the fastening structure of the front connecting portion 11a of the seat frame 11. As in the same manner, in the front connecting portion 11a of the seat frame 11, the frame member 12 is connected via the elastic hinge 400 to the upper seat rail 21, so that the seat frame 11 can pivot at the hinge 400. Even with this modification, the same effect to the first modification can be obtained.

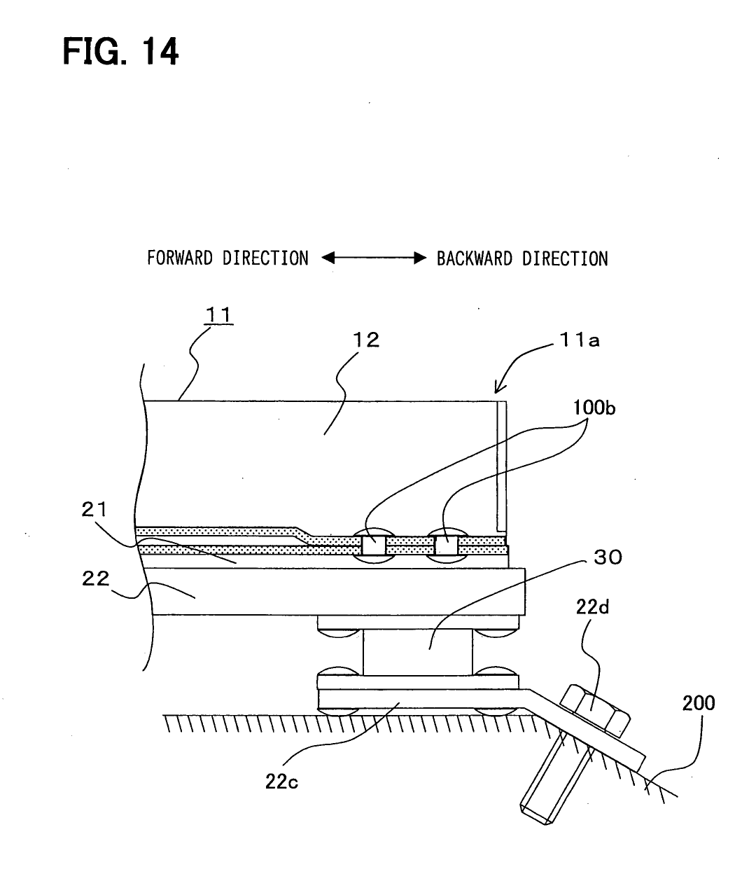

A third modification of the present invention is explained with reference to FIG. 14. In this modification, a pair of weight detecting units 30 are respectively provided between the left-hand lower seat rail 22 and the vehicle body 200 and between the right-hand lower seat rail 22 and the vehicle body 200, so that the weight can be detected by the left and right sides of the seat rear portion 11b.

The rear portion of the seat frame 11 is fastened to the upper seat rail 21 by rivets 100b in the same manner to the front portion of the seat frame 11. On the other hand, the lower seat rail 22 is fixed via the weight detecting unit 30 to the vehicle body. The lower portion of the lower seat rail 22 is fixed to the upper portion of the weight detecting unit 30 by rivets, and the lower portion of the weight detecting unit 30 is fixed to a bracket 22c by rivets. The bracket 22c has been fixed to the vehicle body 200 by a bolt 22d. In this third modification, since the weight detecting units 30 are provided at two (right and left) places, the seat sitting position of the occupant can be detected not only along the front-rear direction, but also along the right-left direction.

Furthermore, since the weight is detected by the weight detecting unit 30 in response to the slide position of the seat frame 11 along the front-rear direction, the deployment control operation of the air bag 40 can be carried out by also considering the slide position of the seat 2.

Furthermore, since the weight detecting operations are separately carried out on the right and left sides of the seat 2, a deployment control operation for a side air bag may be carried out based upon a gravity position of the occupant along the right-left direction of the seat 2.

The present invention is not limited to the above-explained embodiment or modifications, but may be modified and changed without departing from the technical scope and spirit of the present invention.

For example, multiple switching means can be used to detect a slide position of the seat frame in the front-rear direction, wherein those switches will be turned on or off depending on the slide position. And the deployment control signals are generated with a combination of the weight detection signals from the weight detecting unit 30 and the signals from the above switches, so that a more precise operation can be realized. For example, a position switch is provided on the lower seat rail 22, so that the switch is turned ON when the upper seat rail 21 is located at a forward position from the intermediate position, whereas the switch is turned OFF when the upper seat rail 21 is located at a backward position from the intermediate position. As a result, the slide positions of the seat 2 can be detected in two stages.

Further, an image sensing apparatus can be additionally provided for sensing a seat sitting condition of an occupant by an image, so that the information of the occupant detected by the image sensing apparatus and the information detected by the weight detecting unit 30 can be combined. As a result, an occupant condition can be detected in much higher precision.

The fastening structure in the front connecting portion of the seat 2 is not limited to the fastening structures disclosed in the above embodiment or modifications. Any other modified fastening structure can be possible, in which rigidity of a fastening portion to the side of the vehicle body in the front portion of the seat 2 is set to be relatively lower than the rigidity of the weight detecting means which is provided between the vehicle body and the rear portion of the seat 2.

A strain-gage type detecting element, a static capacitance type detecting element or the like can be used, instead of the ceramic resistance element 32, as the weight detecting element, which have been widely and generally utilized.

Furthermore, instead of the deployment control signals of the three stages (the high deployment mode, the low risk deployment mode, and the suppression mode), two stages of the high deployment mode and the suppression mode can be employed.

The expansion control signal can be generated in a linear manner, if the air bag is of a type in which the air bag is controlled in the linear manner.

The present invention can be used to other types of the occupant protecting devices, such as a seat belt device having a pre-tensioning function, a seat belt device in which a seat belt is wound back by an electric motor at a vehicle crash, and so on.

1. A vehicle occupant protection apparatus comprising:
an occupant protecting device;
a seat of a vehicle for an occupant, which is mounted on a floor of the vehicle at a front connecting portion and a rear connecting portion;
a weight detecting unit provided at the rear connecting portion between a rear portion of the seat and the floor of the vehicle and for outputting a weight signal corresponding to a product of a weight of the occupant sitting on the seat and a distance of a gravity of the occupant from the front connecting portion;
a crash sensor provided in the vehicle for outputting a vehicle crash signal; and
a control unit for operating the occupant protecting device in accordance with the weight signal and the crash signal.

2. A vehicle occupant protection apparatus according to claim 1, wherein
a front portion of the seat is fixed to the vehicle floor via a mechanical hinge at the front connecting portion.

3. A vehicle occupant protection apparatus according to claim 2, wherein
the seat is mounted on a seat sliding device, which comprises a pair of lower seat rails, a pair of upper seat rails connected to the lower seat rails in a slidable manner, and
a seat frame of the seat is fixed to the upper seat rails at the front and rear connecting portions via the mechanical hinge and the weight detecting unit.

4. A vehicle occupant protection apparatus according to claim 1, wherein
a front portion of the seat is fixed to the vehicle floor via an elastic hinge at the front connecting portion.

5. A vehicle occupant protection apparatus according to claim 4, wherein
the seat is mounted on a seat sliding device, which comprises a pair of lower seat rails, a pair of upper seat rails connected to the lower seat rails in a slidable manner, and
a seat frame of the seat is fixed to the upper seat rails at the front and rear connecting portions via the elastic hinge and the weight detecting unit.

6. A vehicle occupant protection apparatus according to claim 1, wherein
the mechanical rigidity of the front connecting portion is lower than that of the weight detecting unit, so that a substantial amount of the weight at the rear portion of the seat is applied to the weight detecting unit.

7. A vehicle occupant protection apparatus according to claim 3, wherein
the seat frame comprises a pair of left and right frame members and a coupling member connecting the left and right frame member with each other at a rear portion of the seat,
the upper seat rails is connected with each other by a rail coupling bar, and
the weight detecting unit is provided between the coupling member and the rail coupling bar.

8. A vehicle occupant protection apparatus according to claim 5, wherein
the seat frame comprises a pair of left and right frame members and a coupling member connecting the left and right frame member with each other at a rear portion of the seat,
the upper seat rails is connected with each other by a rail coupling bar, and
the weight detecting unit is provided between the coupling member and the rail coupling bar.

9. A vehicle occupant protection apparatus according to claim 1, wherein
the seat is mounted on a seat sliding device, which comprises a pair of lower seat rails, a pair of upper seat rails connected to the lower seat rails in a slidable manner, and
a seat frame of the seat is fixed to the upper seat rails,
the lower seat rails are connected to the vehicle floor at the front and rear connecting portions, and
the weight detecting unit is provided at the rear connecting portions.

10. A vehicle occupant protection apparatus according to claim 1, wherein
the weight detecting unit comprises a ceramic resistance element.

11. A vehicle occupant protection apparatus according to claim 1, wherein
the weight detecting unit comprises a strain gauge type detecting element.

12. A vehicle occupant protection apparatus according to claim 1, wherein
a predetermined weight is in advance applied to a weight detecting element of the weight detecting unit.

13. A vehicle occupant protection apparatus according to claim 1, wherein
two weight detecting units are provided at the rear connecting portion.

14. A vehicle occupant protection apparatus according to claim 1, wherein
an occupant position detecting means is additionally provided, and
the control unit operates the occupant protecting device in accordance with a signal from the occupant position detecting means in addition to the weight signal and the crash signal.

15. A vehicle occupant protection apparatus according to claim 1, wherein
the occupant protecting device comprises an air bag device.
